(19) United States
(12) Patent Application Publication
(10) Pub. No.: US 2026/0122177 A1
(43) Pub. Date: Apr. 30, 2026

(54) DYNAMIC CALLING LINE IDENTIFIER FOR IMPROVED MESSAGE DELIVERY

(71) Applicant: OPEN TEXT HOLDINGS, INC., Menlo Park, CA (US)

(72) Inventors: Amitava Dutta, Plainsboro, NJ (US); Kathleen L. Achilles, Forked River, NJ (US)

(21) Appl. No.: 18/932,275

(22) Filed: Oct. 30, 2024

(51) Int. Cl. H04M 3/42

(52) U.S. Cl. CPC H04M 3/42059

(57) ABSTRACT

A server system at a first location receives a message destinating a second location and determines whether a calling line identifier (CLI) is provided with the message. If a CLI is not provided with the message, the server system determines whether a customer number is associated with the first location. If a customer number is not associated with the first location, the server system determines a default CLI for the first location. If one is found in a local CLI database, the default CLI is used to make a call to the second location. If multiple ones are found, the server system randomly selects one of them and uses the randomly selected CLI to make a call to the second location, allowing the CLI to be dynamically provisioned without service interruption to call completion.

### TECHNICAL FIELD

This disclosure relates generally to message delivery. More particularly, this disclosure relates to systems, methods, and computer program products for improved message delivery with dynamic calling line identifiers.

### BACKGROUND OF THE RELATED ART

Calling line identification (CLI) is a phone system feature that allows the recipient of a call to see the caller's phone number before answering. CLI is issued by telecommunications carriers, which are also known as network carriers, telecommunications service providers, or simply “carriers.” Carriers are companies that offer services like voice, data, and video transmission to entities like businesses, individuals, and so on.

Generally, carriers examine the CLI of an incoming call to determine if the call is valid, spam, or should be blocked due to high volumes, complaints filed, etc. Based on rules such as those governing spam, carriers can block outgoing messages with certain CLI numbers.

Classically, CLI are static values set on the equipment; whether it be a fax box within a service or sent by a carrier. If and when a CLI gets blocked by downstream carriers, it is a time-consuming process to change the value of the CLI or unblock the CLI. This leads to days of intermittent call completion while waiting for the value to be updated or validated.

In view of the foregoing, there is a need for a way to minimize possible delays caused by having to get a CLI from a carrier without service interruption. The invention disclosed herein can address this need and more.

### SUMMARY OF THE DISCLOSURE

A goal of this disclosure is to provide a computer-implemented solution that allows dynamic CLI settings per call that can be randomly selected and easily updated or removed from a message delivery service (e.g., an email-to-fax service) to ensure ongoing call completion (e.g., a fax is delivered to a fax machine). There can be multiple CLIs per data center or per country to lower the percentage of being identified as spam. The CLI must match the origin of the call and can be service- or customer-specific.

In some embodiments, a method for dynamic generation and use of a calling line identifier can include receiving, by a server system operating on a server machine at a first location in a distributed computing environment, a message destinating a second location. In some cases, the first location and the second location are in different countries. In some cases, the second location comprises a physical or virtual fax machine.

In some embodiments, the server system is operable to determine whether a calling line identifier (CLI) is provided with the message. Responsive to the CLI not being provided with the message, the server system determines whether a customer number is associated with the first location. In some embodiments, determining whether the customer number is associated with the first location comprises accessing a CLI numbers database storing CLIs assigned specifically to the customer number.

Responsive to no customer number being associated with the first location, the server system is operable to determine a default CLI for the first location. This determination can include randomly selecting the default CLI for the first location from a plurality of CLIs for the first location. The default CLI thus randomly selected is then used to make a call to deliver the message to the second location without having to wait for the CLI to be updated and/or validated.

In some embodiments, randomly selecting the default CLI for the first location from a plurality of CLIs for the first location is based on a destination country code for the second location. In some embodiments, randomly selecting the default CLI for the first location comprises cycling through the plurality of CLIs for the second location.

In some embodiments, the message is received from an application on a network appliance or a gateway device that is communicatively connected to a user device associated with an enterprise network. The application, which can be implemented as a service hosted on an email-to-fax server, is configured for receiving content (e.g., an email, a voice message, a document, a text message, etc.) from the user device, converting the content into the message, and injecting the message to the server system. As a non-limiting example, the message can have a faxable format such as an image format.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a flow diagram that illustrates an example of an improved message delivery with dynamic calling line identifier, according to some embodiments disclosed herein.

FIG. 2 depicts a diagrammatic representation of an example of a distributed computing environment where embodiments disclosed herein can be implemented.

FIG. 3 depicts a diagrammatic representation of a data processing system for implementing an embodiment disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As alluded to above, a goal of this disclosure is to provide an automated, flexible solution that allows dynamic CLI settings per call that can be randomly selected (e.g., by cycling through three numbers randomly) and easily updated or removed from a message delivery service (e.g., an email-to-fax service, a business management service, etc., referred to herein as the “service”) to ensure ongoing call completion. While embodiments disclosed herein use an email-to-fax service as an example, customers (e.g., subscribers of the solution) can send faxes in through a variety of electronic methods, including email, FTP, SOAP, SMS, etc. FTP, SOAP, SMS are known to those skilled in the art and, therefore, are not further described herein.

This solution can be implemented on a computer system on the server side, for instance, on a fax server. While a fax server is used as a non-limiting example herein, those of skill in the art understand that the invention disclosed herein can be implemented on other types of server systems, for instance, those configured for servicing a variety of telecommunications, such as sending voice messages, SMS messages, etc. Further, there can be multiple CLIs per data center or per country to lower the percentage of being identified as spam (as part of the telecom-industry standard or protocol). The CLI must match the origin of the call and can be service- or customer-specific.

In some embodiments, the fax server is configured with CLI rules for fax services. Examples of CLI rules are as follows:
CLI must be a number that provides a voice answer or an opt-out feature.
Customers can have their own CLI numbers (i.e., customer-specific CLI numbers) outside of a service provider's CLI numbers.
The CLI number must represent the country from which the destination number is being dialed.
A customer may have multiple CLIs for a single country code. For example, Customer A may define 3 CLIs for the country code “1” and 2 CLIs for country code “81”, etc.
All large customers can provide a CLI or will be assigned (e.g., by the fax server) a customer-specific CLI that is associated with all their outbound traffic. If a CLI is provided by a customer, the destination fax number must provide an opt-out feature and/or be answered by the customer's support personnel.
Smaller customers' traffic can be randomly assigned a service-specific CLI (e.g., a server-provided CLI) and it may differ for each outbound message.

With the invention disclosed herein, a CLI can be readily provisioned and changed by a fax server dynamically while making an outbound call (e.g., in response to an email-to-fax request). Further, the CLI can be set at a customer level (e.g., an entity that subscribes to the service provided by the fax server). Moreover, the CLI will always match the origin of the outbound call.

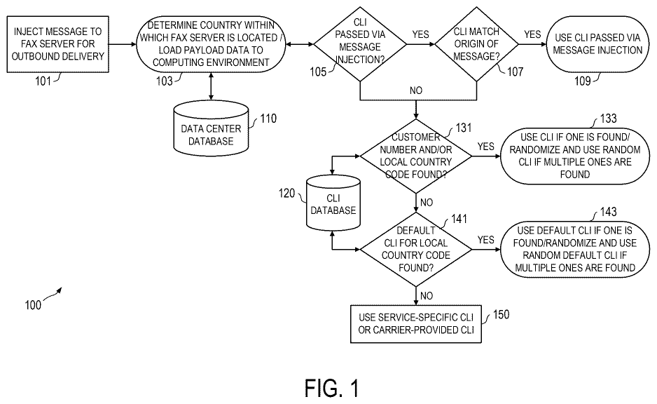

In some embodiments, when a fax is injected by the service for an outbound dialing to a fax number (which can belong to a physical or virtual fax machine), the call setup process uses this invention to determine a correct CLI for making the call (as required by the corresponding carrier). FIG. 1 depicts a flow diagram that illustrates this process.

More specifically, a computer system (e.g., a fax server) that implements a process 100 receives (e.g., from an email-to-fax server) a message (e.g., a fax) for an outbound delivery (101). As a non-limiting example, the email-to-fax server can be implemented on a network appliance such as a gateway device. The fax server (which can be located in a data center) is operable to check a data center database 110 and determines a country code where the fax server is located. The outbound message includes a payload (i.e., the fax) and metadata that describes the payload. At this time, the fax server loads the metadata and the data from the payload in a computing environment (103). The fax server then determines whether a CLI was provided with the outbound message (105). If so, then the fax server determines whether the CLI adheres to the country from which a destination number for the outbound message is being dialed (107). If so, then the CLI thus provided via the message injection is used (109).

As illustrated in FIG. 1, if a CLI is not provided through the message injection, a CLI database 120 is checked to determine whether a customer number and/or a local country code for the fax server can be found (131). If a CLI is found, it is used for dialing the destination number for the outbound message. If multiple CLIs are found, then the CLIs are randomized and one of the CLIs stored in the CLI DB is used for dialing the destination number for the outbound message. If none is found, then the fax server looks for a default CLI that matches the fax server's location (141). This default CLI can be provided by the fax server itself. If a default CLI that matches the fax server's location is found, then the default CLI is used if one is found and randomized if multiple default CLIs are found (143). Otherwise, a default service-specific CLI (e.g., from the fax server) or a CLI from the carrier is used (150).

In some embodiments, the CLI database (DB) 120 contains database tables that, combined with the call setup logic, determine which CLI to use to place the call. These database tables are: CLI Numbers and Data Center Lookup, examples of which are provided below.

### CLI Numbers Database

This database contains the CLI numbers that are either:

1—Assigned specifically to an entity (e.g., a customer or subscriber of the service); whether provided by the customer or assigned from the fax server's default CLI numbers. Each customer can have one or more CLI numbers associated with a country code.

2—A list of service-specific default CLI numbers that can be randomly selected, per country code, and applied to outbound calls.

Example CLI DB with Sample Data

| CustomerNumber | CountryCode | CLI | Notes |
|---|---|---|---|
| 0000000011111111 | 1 | 15554443333 | Customer No |
| 0000000011111111 | 1 | 15554442222 | Customer No |
| 0000000011111111 | 44 | 445512345 | Customer-Specific |
| | | | No. |
| 0000000011111111 | 44 | 445512345 | Customer-Specific |
| | | | No. |
| Default | 1 | 17325551234 | |
| Default | 1 | 17324441235 | |
| Default | 1 | 17324441236 | |
| Default | 44 | 441234567 | |
| Default | 81 | 812345577 | |

In the above database, if customer number 0000000011111111 had an outgoing fax that was transferred to Japan (JPN) for delivery, the default CLI number for the country “81” would be used as the CLI, since this customer does not have an entry for the country code “81”.

### Example Scenarios

Scenario 1—Customer A (i.e., a subscriber of the service disclosed herein) provides their own CLI or the fax server assigns a static CLI to Customer A.

In this case, Customer A provides their own CLI number(s) and the service references Customer A's account number and the list of CLI numbers per destination.

Use case 1: Customer A sends a fax to a US fax number. The service receives the fax and chooses a CLI number from the database that matches the country code for the originating call.

Use case 2: Customer A sends a fax to a fax number in France. Customer A did not provide a French CLI. The service does not have an outbound node in France; however, it transfers the call to the London outbound node The service does not find a match for the Customer Number and country code “44” (UK). The service then checks for an internal default CLI for UK and, if present, uses it. If no default CLI for UK is found internally in the database, the service looks for an internal default CLI for the UK and, if present, uses it. If no internal default CLI for the UK can be found, the service uses the CLI number defined on the carrier control board (which is also known as the carrier printed circuit board). At this time, the service transfer is pulled back to the US node for delivery and the US CLI number is then used by the service.

Scenario 2—Customer A does not have a CLI number assigned to them.

In this case, the service selects a CLI for Customer A's outbound traffic. The service does this for all customers that do not have a static CLI. The service selects the CLI randomly from the available default service CLI numbers based on the location of the originating email-to-fax server location.

### Data Center Lookup Database

Each data center or fax box that can originate a call is assigned a prefix. The prefix is associated with a country code that matches the country of origin. This data is used by the outbound dialing routine to determine the fax box location and country code. This data is used when choosing an appropriate CLI.

As a non-limiting example, below table is used by the call setup to identify the country in which the outgoing call is being placed.

The table lists the data center prefixes, country code, and calling codes from ISO documents and Data Center name, city, and country. This data represents the country codes in which customers can provide a custom CLI. The service uses a list of defaults, randomly selected for each country and for US if no custom CLI is provided by the customer.

### Sample Data:

| | ISO-3166-1 | E.164 Calling | | | |
|---|---|---|---|---|---|
| DC | Alpha-3 | Code | | | |
| Prefix | Country_Code | Calling_Code | DC_Name | City | Country |
| asd | AUS | 61 | Sydney | Sydney, NSW | Australia |
| usl | GBR | 44 | Slough | Slough, England | The United Kingdom |
| wok | GBR | 44 | Woking | Woking, England | The United Kingdom |
| chk | HKG | 852 | Hongkong | Hong Kong | Hong Kong |
| nfp | JPN | 81 | Tokyo | Tokyo | Japan |
| kse | KOR | 82 | Seoul | Seoul | Republic of Korea |
| mkl | MYS | 60 | KualaLampur | Kuala Lampur | Malaysia |
| ams | NLD | 31 | Amstelveen | Amstelveen | The Netherlands |
| ssg | SGP | 65 | Singapore | Singapore | Singapore |
| tbk | THA | 66 | Bangkok | Bangkok | Thailand |
| all | USA | 1 | Allen | Allen, TX | USA |
| ash | USA | 1 | Ashburn | Ashburn, VA | USA |
| lit | USA | 1 | Lithia | Lithia Springs, GA | USA |
| tf | USA | 1 | TintonFalls | Tinton Falls, NJ | USA |
| bp2 | USA | 1 | BrookPark | Brook Park, OH | USA |
| tf | USA | 1 | TintonFalls | Tinton Falls, NJ | USA |

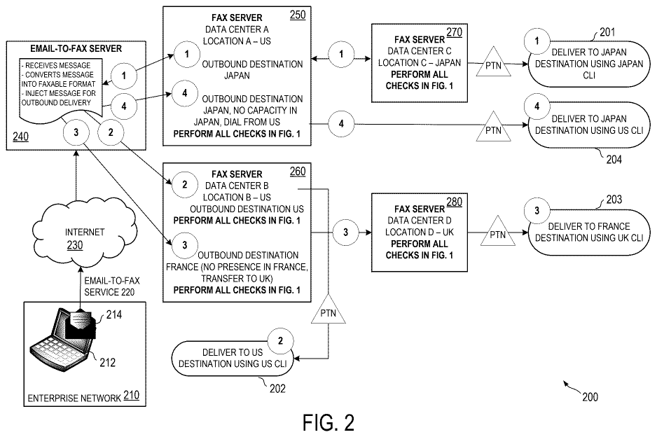

FIG. 2 depicts a diagrammatic representation of an example of a distributed computing environment 200 in which embodiments disclosed herein can be implemented. In this example, four messages (e.g., Message 1, Message 2, Message 3, and Message 4) were sent by an application (e.g., an email program) 214 running on a user device 212 with an enterprise network 210. An entity (e.g., a company, an organization, etc.) that owns and/or operates the enterprise network may subscribe to a service (e.g., an email-to-fax service) 220 hosted on an email-to-fax server 240. Alternatively, a user of the user device 212 may subscribe to the service 220. In some embodiments, the email-to-fax server 240 can be implemented on a network appliance, a gateway device, or the like (e.g., a “fax box”).

Those skilled in the art will appreciate that the service 220 can be provided to the user device 212 in many ways. For instance, in one embodiment the service 220 can be implemented using software as a service (SaaS) technology that allows a user to connect to and use a cloud-based email-to-fax application running in a cloud computing environment. In another embodiment, the service 220 can be implemented as an extension of the application 214. In yet another embodiment, the service 220 can be implemented as a standalone program that, once initiated on the user device 212, connects and acts as a client program to the email-to-fax server 240.

While the user device 212 is used as a non-limiting example in FIG. 2, those skilled in the art will appreciate that the email-to-fax server 240 can be communicatively connected to multiple user devices for providing the service 220 to a plurality of subscribers. In this disclosure, such a subscriber is referred to as a “Customer.” In some embodiments, multiple instances of the service 220 may concurrently run on the email-to-fax server 240, each servicing user devices associated with a corresponding enterprise network.

In the example of FIG. 2, messages (e.g., Message 1, Message 2, Message 3, and Message 4) are communicated via the email-to-fax service 220 from the application 214 on the user device 212 in the enterprise network 210 over the Internet 230 to the email-to-fax server 240. The email-to-fax server 240 is configured for receiving the messages (e.g., emails with and/or without any attachment), converting each of the messages into a fax in a faxable format (e.g., an image in an image file format, such as Tag Image File Format (TIFF), with metadata that describes the image).

In this example, Message 1 is injected (e.g., submitted as a job with a fax payload containing the image and metadata describing Message 1) to a fax server 250 over a server-to-server communication. In this case, the metadata indicates an outbound destination (Japan) 201. The metadata may include additional information such as, but not limited to, a sender of the fax.

The fax server 250, which is located in Data Center A in the United States, referred to as Location A-US, is communicatively connected to a fax server 270 located in Data Center C in Japan, referred to as Location C-Japan. The fax server 250 can ping the fax server 270 (e.g., via an application programming interface (API) call over a server-to-server connection) and understand whether the fax server 270 is available, busy, or unavailable. If the fax server 270 is available, the fax server 250 in Location A-US communicates the job (with the fax payload and the metadata) to the fax server 270 in Location C-Japan over the server-to-server connection (e.g., via an API call). In turn, the fax server 270 performs the checks described above with reference to FIG. 1 and determines a CLI for the local country code (i.e., a Japan CLI). The fax server 270 then delivers the fax to the Japanese destination 201 using the Japan CLI over a Packet Transport Network (PTN) connection. As a non-limiting example, the Japanese destination can be a physical or a virtual fax machine.

Message 2 is injected to a fax server 260 located in Data Center B, which is also in the United States. However, the metadata associated with Message 2 indicates that Message 2 has an outbound destination 202 that is in the United States. The fax server 260 performs all the checks described above with reference to FIG. 1 and delivers Message 2 over a PTN connection to the US destination 202 using a US CLI assigned by the fax server 260.

Message 3 is also injected to the fax server 260 located in Data Center B in the United States. In this case, the metadata associated with Message 3 indicates that Message 3 has an outbound destination 203 that is in France. The fax server 260 performs all the checks described above with reference to FIG. 1 and determines that no data center located in France is able to facilitate this call to France. In turn, the fax server 260 determines that the nearest data center is Data Center D in the United Kingdom and drops Message 3 as a job in a job queue accessible by the fax server 280. The fax server 280 picks up the job, performs all the checks described above with reference to FIG. 1, finds a UK CLI to use, then makes a call over a PTN connection to deliver Message 3 to the France destination 203 using the UK CLI (because the fax server 280 is located in Data Center D in the United Kingdom).

Message 4 is also injected to the fax server 250 located in Data Center A in the United States and has a Japan destination 204. However, in this case, traffic to Japan is congested and/or the fax server 270 in Data Center C in Japan is busy or not available. Thus, the fax server 250 makes a call over a PTN connection to the Japan destination 204 over a PTN connection using the US CLI.

In the example above, each fax server determines, using the incoming metadata, which is the right location from which a call is made, what CLI can be used for the right location, and either makes the call (e.g., over a PTN connection) or communicates (e.g., via an API call) the message at issue to a downstream fax server that can make a local delivery. To the extent that a single CLI is found, the single CLI is used for making the call. Otherwise, if multiple CLIs are found, a randomizer function is applied to randomly select a CLI from the multiple CLIs.

In this way, an appropriate CLI can be readily provisioned and changed for an outbound call, allowing the call to be completed without interruption and without having to wait for a given CLI to be updated or validated. Further, the CLI can be specified at the customer level, providing each customer with the flexibility to use their customer-specific CLI to make calls.

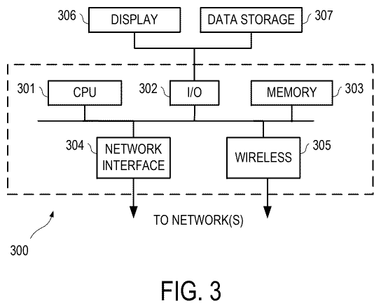

FIG. 3 depicts a diagrammatic representation of a data processing system for implementing an embodiment disclosed herein. As shown in FIG. 3, data processing system 300 may include one or more central processing units (CPU) or processors 301 coupled to one or more user input/output (I/O) devices 302 and memory devices 303. Examples of I/O devices 302 may include, but are not limited to, keyboards, displays, monitors, touch screens, printers, electronic pointing devices (for example, mouse, trackball, stylus, touch pad, etc.), or the like.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device.

Examples of memory devices 303 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 300 can be coupled to display 306, information device 307 and various peripheral devices (not shown), such as printers, plotters, speakers, etc. through I/O devices 302. Data processing system 300 may also be coupled to external computers or other devices through network interface 304, wireless transceiver 305, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

What is claimed is:

1. A method for dynamic generation and use of a calling line identifier, the method comprising:
receiving, by a server system operating on a server machine at a first location in a distributed computing environment, a message destinating a second location;
determining, by the server system, whether a calling line identifier (CLI) is provided with the message;
responsive to the CLI not being provided with the message, determining, by the server system, a customer number associated with the first location;
responsive to no customer number being associated with the first location, determining, by the server system, a default CLI for the first location, the determining comprising randomly selecting the default CLI for the first location from a plurality of CLIs for the first location; and
using the default CLI thus randomly selected to make a call to deliver the message to the second location.

2. The method according to claim 1, wherein randomly selecting the default CLI for the first location from a plurality of CLIs for the first location is based on a destination country code for the second location.

3. The method according to claim 1, wherein the message is received via a service or from an application on a network appliance or a gateway device that is communicatively connected to a user device associated with an enterprise network and wherein the application is configured for receiving content from the user device, converting the content into the message, and injecting the message to the server system.

4. The method according to claim 1, wherein randomly selecting the default CLI for the first location comprises cycling through the plurality of CLIs for the first location.

5. The method according to claim 1, wherein determining the customer number associated with the first location comprises accessing a CLI numbers database storing CLIs assigned specifically to the customer number.

6. The method according to claim 1, wherein the first location and the second location are in different countries.

7. The method according to claim 1, wherein the second location comprises a physical or virtual fax machine.

8. A system, comprising:
a processor;
a non-transitory computer-readable medium; and
instructions stored on the non-transitory computer-readable medium and translatable by the processor for:
receiving, at a first location in a distributed computing environment, a message destinating a second location;
determining whether a calling line identifier (CLI) is provided with the message;
responsive to the CLI not being provided with the message, determining a customer number associated with the first location;
responsive to no customer number being associated with the first location, determining a default CLI for the first location, the determining comprising randomly selecting the default CLI for the first location from a plurality of CLIs for the first location; and
using the default CLI thus randomly selected to make a call to deliver the message to the second location.

9. The system of claim 8, wherein randomly selecting the default CLI for the first location from a plurality of CLIs for the first location is based on a destination country code for the second location.

10. The system of claim 8, wherein the message is received via a service or from an application on a network appliance or a gateway device that is communicatively connected to a user device associated with an enterprise network and wherein the application is configured for receiving content from the user device, converting the content into the message, and injecting the message to the server system.

11. The system of claim 8, wherein randomly selecting the default CLI for the first location comprises cycling through the plurality of CLIs for the first location.

12. The system of claim 8, wherein determining the customer number associated with the first location comprises accessing a CLI numbers database storing CLIs assigned specifically to the customer number.

13. The system of claim 8, wherein the first location and the second location are in different countries.

14. The system of claim 8, wherein the second location comprises a physical or virtual fax machine.

15. A computer program product comprising a non-transitory computer-readable medium storing instructions translatable by a processor for:
receiving, at a first location in a distributed computing environment, a message destinating a second location;
determining whether a calling line identifier (CLI) is provided with the message;
responsive to the CLI not being provided with the message, determining a customer number associated with the first location;
responsive to no customer number being associated with the first location, determining a default CLI for the first location, the determining comprising randomly selecting the default CLI for the first location from a plurality of CLIs for the first location; and
using the default CLI thus randomly selected to make a call to deliver the message to the second location.

16. The computer program product of claim 15, wherein randomly selecting the default CLI for the first location from a plurality of CLIs for the first location is based on a destination country code for the second location.

17. The computer program product of claim 15, wherein the message is received via a service or from an application on a network appliance or a gateway device that is communicatively connected to a user device associated with an enterprise network and wherein the application is configured for receiving content from the user device, converting the content into the message, and injecting the message to the server system.

18. The computer program product of claim 15, wherein randomly selecting the default CLI for the first location comprises cycling through the plurality of CLIs for the first location.

19. The computer program product of claim 15, wherein determining the customer number associated with the first location comprises accessing a CLI numbers database storing CLIs assigned specifically to the customer number.

20. The computer program product of claim 15, wherein the first location and the second location are in different countries and wherein the second location comprises a physical or virtual fax machine.
